(19) United States
(12) Patent Application Publication
(10) Pub. No.: US 2026/0264585 A1
(43) Pub. Date: Sep. 10, 2026

(54) CHILD SAFETY SEAT FOR CARS

(71) Applicant: NINGBO YUANYUAN AUTO ACCESSORIES CO., LTD, Cixi City (CN)

(72) Inventor: Xijiong FU, Cixi City (CN)

(21) Appl. No.: 19/322,990

(22) Filed: Sep. 9, 2025

(30) Foreign Application Priority Data
Mar. 6, 2025 (CN) 202520389542.6

(51) Int. Cl. B60N 2/28

(52) U.S. Cl. CPC B60N 2/2869

(57) ABSTRACT

A child safety seat for a car comprises: a base; a rotating disk rotatably connected within the base and capable of rotating around a rotation axis; a seat body disposed on and connected to the rotating disk, the seat body being capable of driving the rotating disk to rotate around the rotation axis; and further comprising: an annular limiting pressure ring fixedly connected to the base, the rotating disk being disposed between the limiting pressure ring and the base, and a limiting portion formed on the limiting pressure ring, the limiting portion being capable of engaging with the rotating disk to achieve axial limiting of the rotating disk.

### TECHNICAL FIELD

This utility model relates to a seat specifically suitable for use in vehicles to improve child safety, and more specifically to a child safety seat for cars.

### BACKGROUND ART

With improved living standards, more and more people are choosing to install child safety seats in their cars to ensure their children's safety. However, many child safety seat bases are fixed, preventing them from being rotated to adjust the orientation and tilt angle of the child safety seat. This limits the applicability of child safety seats and reduces the comfort and convenience of children.

To address this issue, prior art, such as Chinese utility model patent No. ZL202020289874.4 (publication No. CN211943043U), “A Child Safety Seat with Convenient Tilt and Rotation Angle Adjustment,” discloses a rotatably adjustable child safety seat. The seat body is mounted on and rotates along the rotating disc, and a tension ring is installed below the base, secured to the rotating disc by screws. This serves to constrain the rotating disc within the base, thereby providing constraints other than rotation between the rotating disc and the base. The aforementioned patent achieves seat rotation adjustment via a rotating disc, and the movement of the rotating disc is constrained by a tension ring under the base. However, this solution still has the following drawbacks: During the actual rotation of the rotating disc, the tension ring cannot prevent the rotating disc from tilting outside the rotation plane due to the shifting center of gravity of the seat body and the child seated on it. Furthermore, the weight of the tension ring in the aforementioned patent increases the force required to drive the rotating disc, and the contact surface between the tension ring and the base during rotation further increases the friction of the rotating disc, making seat rotation adjustment more laborious and cumbersome for the user.

### UTILITY MODEL SUMMARY

The technical problem addressed by this utility model is to provide a child safety seat that can stably constrain the rotating disc within the base, making adjustment more labor-saving.

The present invention solves the above-mentioned technical problems by adopting a technical solution:

The child safety seat comprises: a base; a rotating disk rotatably connected to the base and capable of rotating about a rotation axis; a seat body disposed on and connected to the rotating disk, the seat body being capable of driving the rotating disk to rotate about the rotation axis; and is characterized by further comprising: an annular limiting pressure ring fixedly connected to the base, the rotating disk being disposed between the limiting pressure ring and the base, and a limiting portion formed on the limiting pressure ring, which cooperates with the rotating disk to achieve axial limiting of the rotating disk.

To facilitate user rotational adjustment of the seat body, the stopper is formed as a stepped surface protruding inwardly from the inner wall of the stopper pressure ring. The inner wall of the stopper pressure ring has a recessed portion formed below the stopper, which is concave inwardly relative to the stopper. The outer edge of the rotating disk abuts against the stepped surface, located below and aligned with the stopper. A gap is also left between the outer edge of the rotating disk and the recessed portion to allow the rotating disk to rotate. This gap prevents friction between the rotating disk and the stopper pressure ring during rotation, ensuring smooth rotation and effortless adjustment.

To enhance the rotational stability of the rotating disk, the base is further provided with a through-hole. A rotating shaft protrudes axially from the center of the rotating disk. The shaft fits within and extends through the through-hole. The rotating disk is rotatably connected to the base via the shaft, with the central axis of the shaft being referred to as the rotational axis. The rotational connection between the shaft and the through-hole ensures stable circumferential rotation of the rotating disk about the rotational axis.

To enhance the stability of the connection between the rotating disc and the base, a mounting hole is axially penetrated through the rotating shaft. A connecting member is provided between the rotating shaft and the base, extending axially through the mounting hole to axially retain the rotating shaft and the base. This connecting member prevents axial separation between the rotating disc and the base, enhancing safety for children.

To extend the service life of the retaining ring, a retaining plate is provided between the rotating disc and the retaining ring. The retaining plate has a greater structural strength than the retaining ring and is located inside the inner ring wall of the retaining ring. This position of the retaining plate prevents direct friction between the rotating disc and the retaining ring and blocks direct impacts from the rotating disc, enhancing the retaining ring's impact resistance.

To enhance the stability of the connection between the baffle and the stop ring, the stop ring further includes a recessed portion formed inwardly to form a baffle slot for mounting the baffle. The baffle is positioned within the baffle slot.

The baffle includes: A connecting portion having a connecting hole. The stop ring is attached to the base via a fastener that passes through the connecting hole and connects the baffle to the stop ring.

To protect the stop and enhance its impact resistance, the baffle further includes: An L-shaped bend connected to one side of the connecting portion, with the top of the L-shaped bend abutting against the underside of the stop. The L-shaped bend prevents axial impact of the rotating disk on the stop.

To facilitate user adjustment of the rotational position of the rotating disk, the base includes a rotation limit assembly that acts on the rotating disk to limit its rotational position.

To facilitate multiple adjustments of the rotating disk's rotational position, the rotating disk further includes a partially inwardly recessed slot along its outer circumference.

The rotation limit assembly comprises: A latch member, slidably mounted on the base along the rotating disk's radius, is provided with a latch pin. The latch pin engages and is positioned opposite the latch pin.

The position-limiting pressure ring includes a notch for the latch pin to pass through. A compression spring, positioned between the base and the latch member, biases the latch member radially inward along the rotating disk's radius. The user can unlock the rotating disk's rotational position by applying radial force to the latch member. Release of the latch member can also cause the compression spring to rebound, pushing the latch member back to its original position and relocking the rotating disk's rotational position.

To facilitate radial reciprocating movement of the latch member, the base further includes radially distributed sliding holes. A portion of the latch member protrudes downward and is connected to a sliding member, which slidably engages with the sliding holes.

Compared with existing technologies, the advantages of this invention are:
1. The rotating disc of this invention is located between the limiting pressure ring and the base, and cooperates with the limiting portion to achieve axial positioning of the rotating disc. The limiting pressure ring constrains the rotating disc within the base, effectively preventing the rotating disc from fluctuating or tilting outside the rotation plane.
2. The limiting portion of the inner ring wall of the limiting pressure ring is used to axially limit the rotating disc. This allows the rotating disc to be constrained without connecting to other components, reducing the user's rotational force required to rotate the seat body and making rotational adjustment more labor-efficient.

### BRIEF DESCRIPTION OF THE DRAWINGS

FIG. 1 is a schematic diagram of the structure of an embodiment of the present invention;

FIG. 2 is an exploded view of the structure of an embodiment of the present invention;

FIG. 3 is a schematic diagram of the assembly relationship between the limit pressure ring, base, and rotating disk of an embodiment of the present invention;

FIG. 4 is a schematic diagram of the structure of the limit pressure ring of an embodiment of the present invention;

FIG. 5 is a schematic diagram of the structure of the baffle of an embodiment of the present invention;

FIG. 6 is a schematic diagram of the structure of the rotating disk of an embodiment of the present invention;

FIG. 7 is a schematic diagram of the structure of the rotation limit assembly of an embodiment of the present invention;

FIG. 8 is a longitudinal cross-sectional view of an embodiment of the present invention;

FIG. 9 is an enlarged partial view of point A in FIG. 8;

FIG. 10 is an enlarged partial view of point B in FIG. 8;

FIG. 11 is an enlarged partial view of point C in FIG. 8.

### DETAILED DESCRIPTION

The present invention will be described in further detail below with reference to the accompanying drawings and embodiments.

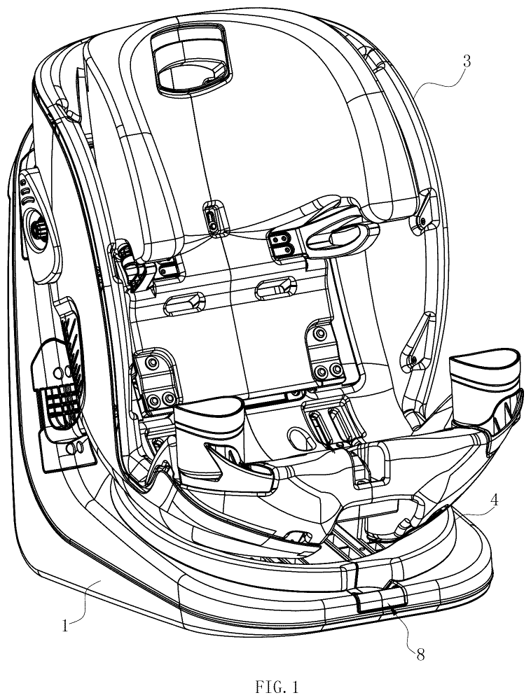

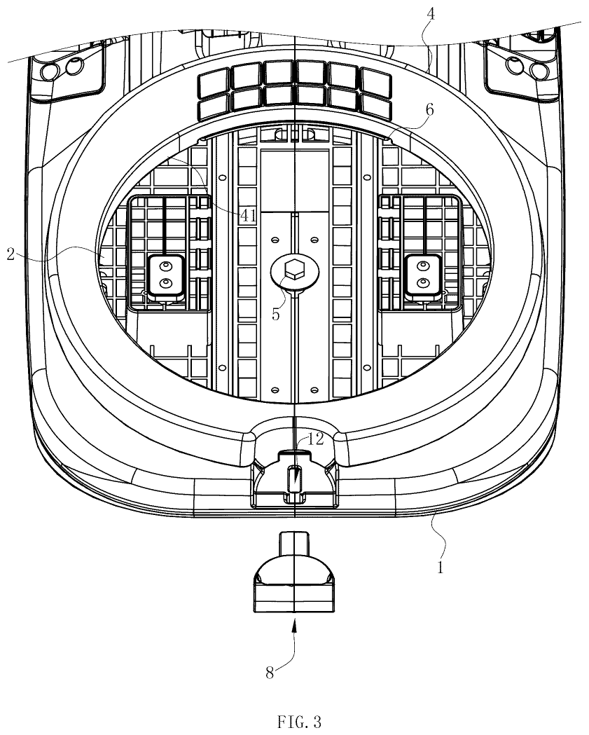

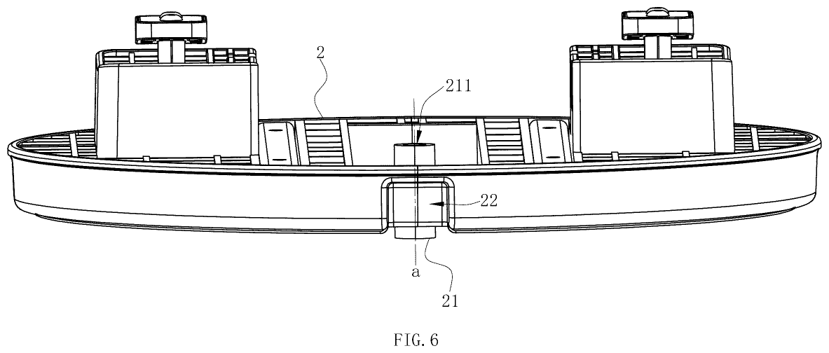

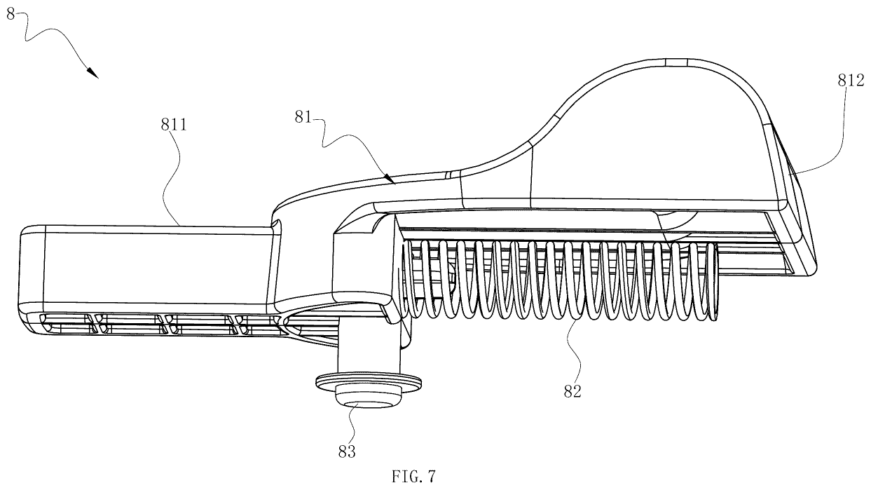

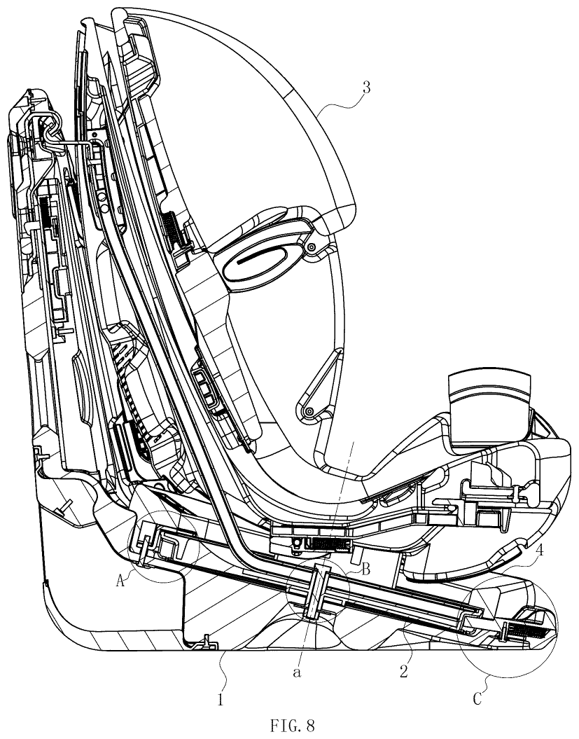

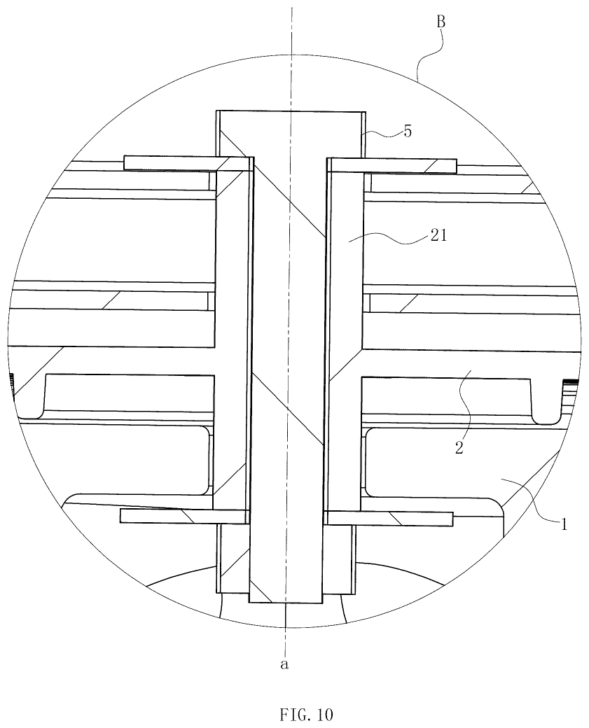

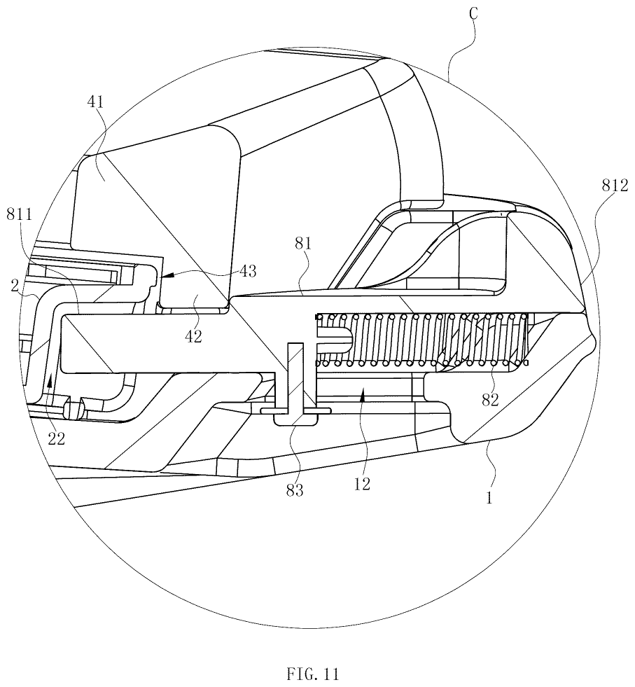

FIGS. 1 to 11 illustrate a preferred embodiment of the present invention. The child safety seat of this embodiment is primarily used to ensure the safety of children in a car. Existing child safety seats have a rotational adjustment function, which is achieved by the seat body driving a rotating disk. During rotation, the rotating disk can easily shift or even separate from the base due to the shifting center of gravity of the seat body and the child, posing a risk to the child. Therefore, it would be beneficial to provide a child safety seat that can restrain the rotating disk within the base. The structure of the child safety seat of this embodiment is described in detail below:

Referring to FIGS. 1 to 3, the child safety seat of this embodiment is shown in FIGS. 1 to 3. The child safety seat comprises a base 1, a rotating disk 2 rotatably connected to the base 1, a seat body 3 mounted on the rotating disk 2, and a limiting pressure ring 4 fixedly connected to the base 1. The rotating disk 2 is rotatable about a rotation axis a. The seat body 3 is connected to the rotating disk 2 and can drive the rotating disk 2 to rotate about the rotation axis a. The limiting pressure ring 4 is annular in shape, with the rotating disk 2 disposed between the limiting pressure ring 4 and the base 1. A limiting portion 41 is formed on the limiting pressure ring 4, which cooperates with the rotating disk 2 to achieve axial positioning of the rotating disk 2.

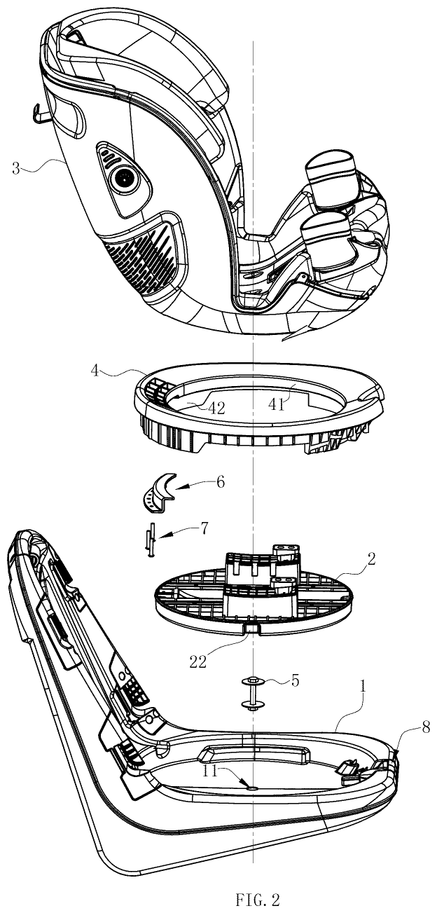

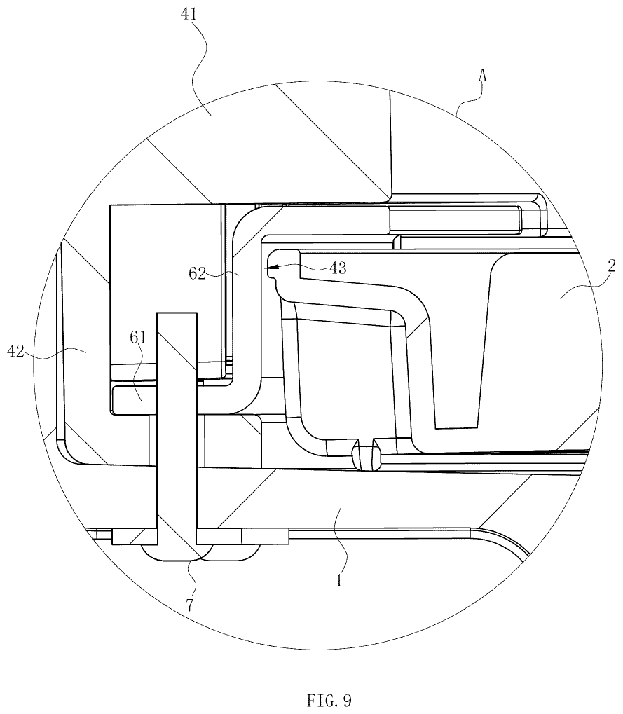

Referring to FIGS. 2 and 9, the stopper 41 is a stepped surface formed by a circumferential inward protrusion on the inner wall of the stopper pressure ring 4. Below the stopper 41, the inner wall of the stopper pressure ring 4 has a recessed portion 42 formed thereon, which is concave inward relative to the stopper 41. The outer edge of the rotating disk 2 abuts against the stepped surface below and aligned with the stopper 41. A gap 43 is also left between the outer edge of the rotating disk 2 and the recessed portion 42, allowing the rotating disk 2 to rotate. This gap 43 prevents friction between the rotating disk 2 and the stopper pressure ring 4 during rotation, ensuring smooth rotation and effortless adjustment, making it easier for the user to rotate the seat body 3.

Referring to FIGS. 2, 6, and 10, the base 1 is provided with a through-hole 11. A rotating shaft 21 is formed axially protruding from the center of the rotating disc 2. The rotating shaft 21 fits within and extends through the through-hole 11. The rotating disc 2 is rotatably connected to the base 1 via the rotating shaft 21. The central axis of the rotating shaft 21 is designated as the rotation axis a. The rotational connection between the rotating shaft 21 and the through-hole 11 enables the rotating disc 2 to rotate stably about the rotation axis a, thereby enhancing the rotational stability of the rotating disc 2.

A mounting hole 211 is axially formed through the rotating shaft 21. A connecting member 5 is provided between the rotating shaft 21 and the base 1. The connecting member 5 extends axially through the mounting hole 211 to axially retain the rotating shaft 21 to the base 1. The provision of the connecting member 5 prevents axial separation between the rotating disc 2 and the base 1, thereby increasing the stability of the connection between the rotating disc 2 and the base 1 and improving the safety of children.

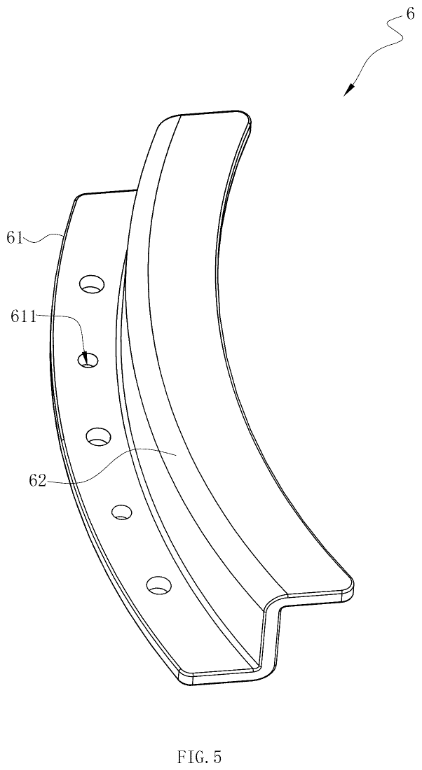

Referring to FIGS. 2 and 9, a baffle 6 is provided between the rotating disk 2 and the limiting pressure ring 4. This baffle 6 has a greater structural strength than the limiting pressure ring 4 and is located inside the inner wall of the limiting pressure ring 4. This location prevents direct friction between the rotating disk 2 and the limiting pressure ring 4 and prevents direct impact from the rotating disk 2 on the limiting pressure ring 4, thereby extending the service life of the limiting pressure ring 4 and enhancing its impact resistance. Referring to FIGS. 5 and 9, the recessed portion 42 of the limiting pressure ring 4 is recessed to form a baffle groove 44 for mounting the baffle 6. The baffle 6 is positioned within this baffle groove 44 and comprises a connecting portion 61 and an L-shaped bent portion 62. The connecting portion 61 is provided with a connecting hole 611. The limiting pressure ring 4 is attached to the base 1 via a fastener 7, which passes through the connecting hole 611 in the connecting portion 61 and connects the baffle 6 to the limiting pressure ring 4, thereby enhancing the stability of the connection between the baffle 6 and the limiting pressure ring 4. The L-shaped bent portion 62 is connected to one side of the connecting portion 61, with the top of the L-shaped bent portion 62 abutting against the underside of the limiting portion 41. The L-shaped bent portion 62 can block axial impacts of the rotating disk 2 on the limiting portion 41, thereby protecting the limiting portion 41 and enhancing its impact resistance.

Finally, referring to FIGS. 2, 3 and 8, a rotation limiting assembly 8 is provided on the base 1, which can act on the rotating disk 2 to limit the rotation position of the rotating disk 2, making it convenient for the user to adjust the rotation position of the rotating disk 2.

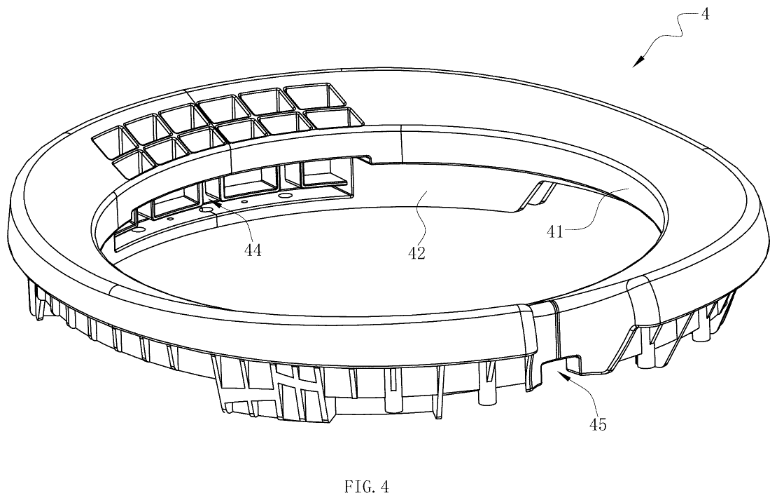

Referring to FIGS. 4, 6, 7 and 11, a slot 22 is recessed inwardly in the circumferential direction of the outer edge of the rotating disk 2, and four slots are evenly spaced around the circumference of the rotating disk 2. The rotation limit assembly 8 includes a bayonet member 81 and a compression spring 82, wherein the bayonet member 81 is slidably arranged on the base 1 along the radial direction of the rotating disk 2, and a bayonet member 811 is provided on the bayonet member 81. A handle 812 exposed on the outer surface of the base 1 is provided on the bayonet member 81, and the bayonet member 81 is adapted to the slot 22 and arranged relative to each other. The limiting pressure ring 4 is provided with a notch 45 for the bayonet pin 811 to penetrate into the slot 22; the compression spring 82 is arranged between the base 1 and the bayonet member 81, and has a tendency to radially press the bayonet member 81 radially inward along the radial direction of the rotating disk 2. The user can unlock the rotating disk 2's rotational position by applying radial force to the latch 81.

Alternatively, releasing the latch 81 causes the compression spring 82 to rebound, pushing the latch 81 back to its original position and relocking the rotating disk 2, making it easy for the user to adjust the rotating disk 2's rotational position multiple times. The base 1 includes radially distributed sliding holes 12. The latch 81 partially protrudes downward and is connected to a sliding member 83. The sliding member 83 slidably engages with the sliding hole 12, facilitating radial reciprocating movement of the latch 81. The operating principle of this embodiment of the child safety seat is as follows: the retaining ring 4 holds the rotating disk 2 within the base 1. Specifically, the retaining portion 41, the retaining plate 6, the L-shaped bend 62, and the fastener 7 restrict axial outward movement of the rotating disk 2. The through hole 11 cooperates with the rotating shaft 21 to limit radial movement of the rotating disk 1 relative to the base 1. A gap 43 is also left between the outer edge of the rotating disk 2 and the recessed portion 42, allowing the rotating disk 2 to rotate smoothly. The user pulls the latch 81 outward, disengaging the latch 811 from the slot 22 while simultaneously rotating the seat body 3. When the latch 811 aligns with the other slot 22, the user releases the latch 81, causing the compression spring 82 to push the latch 81 back into the slot 22, completing the rotation adjustment.

1. A child safety seat for a car, comprising: a base (1); a rotating disk (2), rotatably connected to the base (1) and capable of rotating around a rotation axis (a); a seat body (3), disposed on the rotating disk (2) and connected to the rotating disk (2), the seat body (3) being capable of driving the rotating disk (2) to rotate around the rotation axis (a); and characterized in that it further comprises: a ring-shaped limiting pressure ring (4), fixedly connected to the base (1), the rotating disk (2) being disposed between the limiting pressure ring (4) and the base (1), and a limiting portion (41) being formed on the limiting pressure ring the limiting portion (41) being capable of cooperating with the rotating disk (2) to limit the rotating disk (2) in the axial direction.

2. The child safety seat for automobiles according to claim 1, characterized in that: the limiting portion (41) is a limiting step surface formed by the inner ring wall of the limiting pressure ring protruding inward in the circumferential direction, the inner ring wall of the limiting pressure ring (4) is formed with a concave portion (42) below the limiting portion (41) and concave inward in the circumferential direction relative to the limiting portion (41), the outer edge of the rotating disk (2) is abutted against the limiting step surface located below the limiting portion (41) and against the limiting portion (41), and at the same time A gap (43) is left between the outer edge of the rotating disk (2) and the recessed portion for the rotating disk (2) to rotate.

3. The child safety seat for a car according to claim 1, characterized in that: the base (1) is provided with a through hole (11), and a rotating shaft (21) is formed axially protruding at the center of the rotating disk (2), the rotating shaft (21) is adapted to and penetrates the through hole (11), and the rotating disk (2) is rotatably connected to the base (1) via the rotating shaft (21), and the central axis of the rotating shaft (21) is recorded as the rotating axis (a).

4. The child safety seat for a car according to claim 3, characterized in that: the rotating shaft (21) is axially provided with a mounting hole (211), and a connecting member (5) is provided between the rotating shaft (21) and the base (1), and the connecting member (5) axially penetrates the mounting hole (211) to axially limit the connection between the rotating shaft (21) and the base (1).

5. The child safety seat for a car according to claim 1, characterized in that a baffle (6) is provided between the rotating disk (2) and the limiting pressure ring (4), the structural strength of the baffle (6) being greater than that of the limiting pressure ring (4), and the baffle (6) being located on the inner side of the inner ring wall of the limiting pressure ring (4).

6. The child safety seat for a car according to claim 5, characterized in that a baffle groove (44) for mounting the baffle (6) is formed inwardly on the recessed portion (42) of the limiting pressure ring (4), the baffle (6) being disposed in the baffle groove (44), the baffle (6) including a connecting portion (61), the connecting portion (61) being provided with a connecting hole (611), the limiting pressure ring (4) being provided on the base (1) via a fastener (7), the fastener (7) passing through the connecting hole (611) on the connecting portion (61) and connecting the baffle (6) to the limiting pressure ring 7. The child safety seat for a car according to claim 6, characterized in that the blocking piece (6) further comprises: An L-shaped bent portion (62), the L-shaped bent portion (62) being connected to one side of the connecting portion (61), the top of the L-shaped bent portion (62) being in contact with the lower surface of the limiting portion (41).

8. The child safety seat for a car according to claim 1, characterized in that a rotation limiting assembly (8) is provided on the base (1), the rotation limiting assembly (8) being capable of acting on the rotating disk (2) to thereby limit the rotational position of the rotating disk (2).

9. The child safety seat for a car according to claim 8, characterized in that: a slot (22) is provided inwardly on the outer edge of the rotating disk (2), and the rotation limiting assembly (8) comprises: a latch member (81) slidably arranged on the base (1) along the radial direction of the rotating disk (2), a latch member (811) being provided on the latch member (81), the latch member (81) being adapted to and arranged relative to the slot (22), and a notch (45) for the latch member (811) to penetrate the slot (22); and a compression spring (82) provided between the base (1) and the latch member (81), having a tendency to press the latch member (81) radially inwardly along the radial direction of the rotating disk (2).

10. The child safety seat for a car according to claim 9, characterized in that: radially distributed sliding holes (12) are formed on the base (1); the latch member (81) partially protrudes downward and is connected to a sliding member (83); the sliding member (83) slides in engagement with the sliding hole (12).
